(19) United States
(12) Patent Application Publication
(10) Pub. No.: US 2003/0230319 A1
(43) Pub. Date: Dec. 18, 2003

(54) Flavor enhanced dental floss

(76) Inventors: Robert Victor Marcon, Niagara Falls (CA); Lawrence Wayne Nash, St. Catharines (CA)

Correspondence Address: ROBERT V. MARCON, 3471 SINNICKS AVENUE, NIAGARA FALLS, ON, L2J 2G6, CA

(21) Appl. No.: 10/461,723

(22) Filed: Jun. 13, 2003

Related U.S. Application Data
(60) Provisional application No. 60/388,979, filed on Jun. 14, 2002.

(51) Int. Cl. A61C 15/00

(52) U.S. Cl. 132/321

(57) ABSTRACT

The present invention detailed herein describes a flavor enhanced dental floss or FED floss that is able to provide an exceptionally intense and long lasting release of flavor, as well as, all of the traditional benefits normally associated with flossing. In addition, this new FED floss is also able to utilize one or more other chemical compounds such as fluoride based compounds, polishing or abrading agents, peroxide compounds, and pigmenting agents in order to provide various other therapeutic or cosmetic effects. As such, a flavor enhanced dental floss is therefore able to provide a safe, convenient, inexpensive, and good tasting consumer product that is not only highly desirable but effective as well.

### CROSS-REFERENCE

This application claims priority from U.S.A. Provisional Application, serial No. 60/388,979, filed Jun. 14, 2002.

### FEDERALLY SPONSORED RESEARCH OR DEVELOPMENT STATEMENTS

Not applicable.

### REFERENCE TO A MICROFICHE APPENDIX

Not applicable.

### BACKGROUND OF THE INVENTION

This invention relates to dental flosses and, specifically, to a flavor enhanced dental floss that possess both heighten and longer lasting flavor characteristics as well as various other beneficial attributes.

It is generally recognized by the dental profession that plaques, including those that are found between the interproximal surfaces of teeth, are a major cause of both dental decay and inflammatory periodontal disease. These plaques, which can contain 250 or more separate microbial species, use sugars and other fermentable carbohydrates to produce polymers which bind the organisms to the surface of teeth and acids which cause their demineralization. In the first stages, a carious lesion does not contain an actual cavity but with prolonged and repeated demineralization by these plaque created acids, a cavity will form. Thus, each time something sweet is consumed plaques produce approximately 20 minutes of oral acid which, in turn, seriously contributes to dental demineralization.

Furthermore, plaques, if not removed will in time form calculus, and calculus, is the mineralized bacterial plaque deposits found on teeth, restorations, and other solid oral structures. Invariably, calculus is covered by a film of plaque, the organisms of which also occupy its porous structure. Its composition is generally made up of seventy percent organic salts, and a thirty percent combination of micro-organisms and organic material. Moreover, its formation is always preceded by plaque accumulation which serves as an organic matrix for the subsequent mineralization of the deposit. Mineralization, by the precipitation of the mineral salts in plaque can start at any time from the second to the fourteenth day of plaque formation, but some individuals can begin to calcify plaque in four to eight hours. Initially, small crystals develop close to these bacteria. Then, gradually, the intermicrobial matrix becomes entirely calcified and eventually the bacteria itself also becomes mineralized.

As a result, the presence of calculus not only makes effective oral hygiene impossible but can also seriously irritate gum tissues. Thus, its prevention and or removal to help control the inception or progression of inflammatory periodontal disease is of great importance. It is also the reason why dental professionals have always recommended flossing, in addition to the conventional practice of using a brush and dentifrice, for flossing clears the interproximal surfaces of the teeth in a manner that a toothbrush, with or without a dentifrice, cannot achieve. With this two step cleaning method effective oral hygiene is, therefore, greatly improved.

However, while flossing has increased in the general population it is still only practiced by a relatively small percentage of the adult population. That is because people, in general, have not fully realized nor appreciated flossing's many inherent and beneficial attributes. Moreover, they view flossing as a preventative measure providing only long term care while immediate pleasures and other advantages are relatively minimal. They also see flossing as a chore and not as a means of improving the overall appearance, smell or taste of the mouth.

Despite this myopic attitude, flossing may yet achieve a greater overall acceptance if people could see some immediate or tangible advantage by its use. This could include, for example, substantially improving a floss's flavor release so as to make it more desirable. Moreover, such an improved flavor release may also help to reduce or mask the odoriferous effects of halitosis. Such advantages, if realized, would certainly garner instant consumer interest. Unfortunately, the flossing industry does not as yet know how to produce such a floss, despite many years of study, research, and experimentation.

With these thoughts in mind it becomes self-evident that there is a large deficiency with contemporary dental flosses in providing satisfactory remedies to the aforedescribed problems. In consequence, the invention detailed within this disclosure can provide a more effective and desirable solution than can be currently achieved.

### OBJECTS AND ADVANTAGES

The flavor enhanced dental floss described herein overcomes many of the drawbacks listed in the prior art while also providing a more effective solution and improved performance over presently used dental flosses. In addition, some of the objects and advantages associated with this invention are described below. Others will become apparent as the description proceeds.

Objects:

(1) To create a dental floss with a remarkably intense, long lasting, and desirable taste.

(2) To create a dental floss possessing both improved taste and fluoride.

(3) To provide a new and improved method of making said dental flosses.

(4) To help reduce oral plaques and the dental problems they cause.

Advantages:

(1) By creating a floss with exceptionally good flavor characteristics consumers will be much more likely to use it, thereby substantially increasing the overall level of flossing within the general population.

(2) The superior flavor release demonstrated by this new floss is not only immediately evident but long lasting as well.

(3) By adding one or more fluoride based compounds to this new floss, oral dental health is improved further still.

(4) Various abrading or pigmenting agents may also be used by this new floss in order to respectively provide cleaner dental surfaces or whiter teeth. In turn, this will not only help reduce dental decay but also increase the therapeutic effectiveness of other medicaments.

(5) This new floss, though revolutionary in its manufacture, is not expensive to make, but is rather well within traditional expectations.

(6) The manufacture of this new dental floss requires no major alterations to existing equipment or facilities but is instead readily compatible with conventional machines and processes. As such, costs are kept low and market penetration expedited.

(7) The chemical stability of this new floss is remarkable. This, therefore, provides not only a long shelf life but lower shipping, storage, and spoilage costs as well.

### SUMMARY OF THE INVENTION

The present invention detailed herein describes a new flavor enhanced dental floss that is able to provide an exceptionally long lasting release of flavor, as well as all of the traditional benefits normally associated with flossing. However, this superior flavor release is best achieved only when a Staged Preparation Technique is used in making the formulations detailed herein. In other words, Staged Preparation Techniques provide the best blending methods to enable these unique formulations to effectively release their full flavor potential in an effective and efficient manner. That is because it allows manufacturers to fully utilize liquid flavorings instead of just powdered compositions, as is now essentially the case. Consequently, the flavor release experienced by these formulations, although quite good, will not be as good, as when a Staged Preparation Technique is used.

In addition, this new floss is also able to utilize one or more fluoride based compounds so that the flossing population may benefit accordingly. Other chemical compounds such as abrading or pigmenting agents may also be added to the formulations herein contemplated in order to provide various other therapeutic or cosmetic effects.

As a result, this new flavor enhanced dental floss is able to provide many benefits to its users. It can, for example, diminish dental plaques and other related dental diseases as well as provide heightened and extended flavor sensations. Cosmetically, teeth will also tend to be whiter and appear healthier and, in final summation, all of this can be accomplished effectively, conveniently, inexpensively, and safely.

### BRIEF DESCRIPTION OF THE DRAWINGS

Not applicable.

### DETAILED DESCRIPTION OF THE INVENTION

Introduction

The present invention pertains to a flavor enhanced dental floss or FED floss. While such a floss is obviously desirable it is achieved in a most unique and novel manner using a method which is herein called a Staged Preparation Technique.

As such, it is to this end that the following description is therefore provided to enable any person skilled in the art to make and use the invention herein disclosed. Various modifications, however, will remain readily apparent to those skilled in the art, as the generic principles of the present invention have been defined herein specifically to provide for the description of a flavor enhanced dental floss or FED floss.

That said, a flavor enhanced dental floss of the present invention begins with a basic or root structure that comprises at least one suitable or commercially available dental floss, binder, flavoring agent, emulsifying agent, and when desired, one or more sweetening agents and or fluoride compounds. While other ingredients may also be added to achieve other effects, these will form the basic or root formulations used herein. However, it must also be understood that all ingredients, compounds or components, regardless of the final formulation used, must be safe, present no danger to the body, teeth or soft tissues of the mouth nor create a discolorment in their appearance. Moreover, they should be inexpensive, easy to use and apply, non-irritating, and require minimal application time. Their individual procurement may also be derived from either natural or synthetic sources or a combination thereof so as to maximize formulation flexibility and manufacturing logistics.

With these thoughts in mind, the description will now individually detail these root components first, in order to more fully explain their individual compositions, applications, and functions. Thereafter, the description will detail various additional components, novel formulations, and manufacturing methods, followed by some closing thoughts, and the addendum.

Dental Flosses

The meaning of the words, “dental floss(es)”, shall be herein understood to include both dental flosses and dental tapes as well as any other similar article. Moreover, the dental flosses and tapes used in the present invention may include any suitable or commercially available dental floss or tape. These flosses and tapes can also be fabricated from either natural or synthetic sources examples of which include, but are not limited to, fibres, filaments or yarns of high and normal tenacity polymers, nylon, polyolefins, polyethylene, polypropylene, fluorocarbon compounds, polytetrafluoroethylene, rayon, dacron, acrylic, acetate polymers, and other plastics alone or in combination. Natural substances may include, but are not limited to, cotton, wool, silk, linen, and other staple fibres alone or in combination. Blends of synthetic-natural fibres can also be used. However, synthetic filaments are preferred for they are more durable, stronger, generally less expensive, and easier to work and procure.

The length, diameter, structure or design of the floss itself is also not limited to any specific size, shape, arrangement or configuration and thus, can be fabricated to suite any specific intention. It can, for example, be composed of a plurality of individual filaments that have been formed together to give a larger thread having a sufficiently small diameter to permit insertion between the teeth. It can also comprise a composite multifilament yarn bonded to an extruded monofilament or to another multifilament yarn. A single circular, square or rectangular shaped monofilament thread is also useful. Other suitable variations are also well known in the art and as such are also useable in the invention herein.

Binders

Binders are used in the invention disclosed herein to bind or otherwise attach to a dental floss the ingredients herein specified by this disclosure. They also provide the ability to alter the frictional characteristics of dental floss as well as help bind together the individual filaments comprising the floss itself. Moreover, the varieties used herein are not restricted to any specific types or compositions and are thus, given great freedom in their formulations, structures or make-ups. Examples of some suitable binders may therefore include, but are not limited to, natural waxes from insects, animals or plants, synthetic waxes, petroleum waxes such as polyethylene glycol wax, microcrystalline wax, liquid polyethylene glycol esters of beeswax as well as other water soluble or non-water soluble wax or wax-like compounds, or non-toxic water soluble or non-water soluble polymers, soaps, gums, resins, and other substances known in the art.

Emulsifying Agents

While various other emulsifying agents may also be employed alone or in combination within this new floss, two preferred compounds will now be specified. They are sorbitan monostearate, and polysorbate 60, both of which are well known and recognized emulsifying agents. Of these two, sorbitan monostearate is the more preferred but the use of either one or both of these two agents, within the formulations listed below, will substantially increase overall performance. That is because emulsifying agents such as these allow the formulation's individual chemical compounds to better interact, disperse, and disseminate upon various dental surfaces in a much more efficient and effective manner. In turn, this makes the final product not only better but more consistent as well.

Flavoring Agents

A flavor enhanced dental floss may also utilize one or more flavoring agents. These may comprise essential oils, synthetic flavors, or mixtures thereof including, but not limited to, oils derived from plants and fruits such as citrus oils, fruit essences, mint, peppermint oil, spearmint oil, clove oil, oil of wintergreen, anise, sassafras, sage, eucalyptus, marjoram, cinnamon, lemon, orange, banana, cherry, apple, pineapple, grape, strawberry, blueberry, tutti frutti, methyl salicylate, Hagelin flavoring #640047, Hagelin flavoring #640057, Hagelin flavoring #671009, Hagelin flavoring #671010, and the like. Those skilled in the art will recognize that natural and artificial flavoring agents may be used independently or combined in any sensorially acceptable blend. All such flavors and flavor blends are contemplated by the present invention.

Solubilizing Agents

FED floss formulations will also make use of one or more solubilizing agents. Their function as such, will be to aid in dissociation. Suitable solubilizing agents may therefore include, but are not limited to, filtered water, reverse osmosis water, distilled water, and deionized water, alone or in combination. However, deionized water has been found preferable to the others.

Sweetening Agents

To foster greater consumer appeal a flavor enhanced dental floss may also contain one or more natural or artificial sweetening agents alone or in combination. These may include, but are not limited to, sucrose, lactose, dextrose, maltose, dextrin, dried inverted sugar, fructose, levulose, galactose, corn syrup and their solids, sorbitol, mannitol, xylitol, hydrogenated starch hydrolysates, maltitol, sucralose, aspartame, salts of acesulfame, alitame, saccharin and its salts, cyclamic acid and its salts, glycyrrhizin, dihydrochalcones, thaumatin, monellin, and the like. Though any type, variety or blend of sweetener may be used, compounds which substantially reduce the potential for cariogenic decay are preferred.

Fluorides

Fluorides have in the past been found to help prevent the incidence of carious lesions or caries. Caries are caused when teeth demineralize at a rate faster than they remineralize and most demineralization is caused by acid producing dental plaques. Remineralization, however, is promoted by calcium and phosphate, the chief remineralizing agents found also in saliva. Fluoride based compounds, therefore, provide protection from carious lesions or caries by acting as a catalyst to speed the precipitation of calcium phosphate, in the form of a hydroxy apatite, onto or into teeth. However, this is not fluoride's only role. It is also able to inhibit the activity of some bacterial enzymes and their acid producing processes, and at extremely high concentrations it can also kill certain plaque bacteria. Even more important, it tends to become incorporated into the apatite, as a fluoridated hydroxy apatite or “fluorapatite”, creating a mineral that is appreciably less dissolvable by acid.

Hence, flavor enhanced dental flosses may contain one or more fluoride based compounds. These compounds may also be slightly soluble in water or may be fully water soluble. They are, however, foremost characterized by their ability to release fluoride ions in water and their freedom from undesired reactions with the FED floss's other compounds. Among these materials are numerous fluoride based compounds which can comprise inorganic fluoride salts such as soluble alkali metal, alkaline earth metal salts, and others. Examples of such include, but are not limited to, sodium fluoride, potassium fluoride, ammonium fluoride, a copper fluoride such as cuprous fluoride, zinc fluoride, sodium fluorosilicate, ammonium fluorosilicate, sodium fluorozirconate, barium fluoride, calcium fluoride, sodium monofluorophosphate, sodium silicofluoride, aluminum mono- and di-fluorophosphate, and fluorinated sodium calcium pyrophosphate. However, alkali metal and tin fluorides, such as sodium and stannous fluorides, sodium monofluorophosphate (MFP), amine fluoride, and mixtures thereof, are preferred.

When a fluoride compound is employed, the amount used is dependent to a large extent upon the type of fluorine compound, its solubility, and the final formulation and structure selected. As such, substantial leeway is given to the quantities or amounts used as long as normal formulation and pharmaceutical safeguards are observed.

Optimizing the effects and benefits of fluorides as well as other medicaments is also of prime importance to both manufactures and consumers alike. One way of accomplishing this is to provide as plaque free a dental enamel surface as possible. That is because most medicaments, in general, tend to function better when given a cleaner dental surface on which to work. In this respect, the incorporation into the flavor enhanced dental floss of one or more peroxide based compounds, polishing or abrading agents, or other similar scrubbing or cleaning ingredients can improved results because such substances tend to attack and remove plaques. As these plaques diminish, the dental and oral impact of various medicaments will be much more effective and useful.

Polishing or Abrading Agents

One or more polishing or abrading agents may also be utilized in the flavor enhanced dental floss. Moreover, the type of abrading agents employed are not restricted to any specific types or quantities. This, therefore, allows the abrading compounds used to better suit the final effects desired. In any case, their incorporation will help clean and polish teeth and so help produce a smooth and shiny surface that will resist discoloration, bacterial accumulation, and retention. Cleaner teeth also help to improve the therapeutic performance of other ingredients such a fluorides as well as reduce the overall quantity of bacterially produced acid.

As such, a FED floss may make use of one or more polishing or abrading agents which may include, but are not limited to, a boride, carbide, carbonate, bicarbonate, nitride, oxide, dioxide, phosphate, silicate or sulphide of such elements as aluminum, calcium, iron, magnesium, potassium, silicon, sodium, tin, titanium, tungsten, zinc, and zirconium, alone or in combination.

Peroxide Compounds

An flavor enhanced dental floss may also make use of one or more peroxide based compounds such as, but not limited to, calcium peroxide, sodium carbomate peroxide, and sodium carbonate peroxide. Their use will help remove dental plaques and whiten teeth and so thereby reduce the incidence of dental caries and other related diseases. This ability to reduce dental decay stems from the fact that oxygen is released during their decompositions. Thus, when a peroxide based compound is utilized in the mouth the decomposal release of oxygen will not only vigorously attack bacterial plaques but also help whiten teeth. In addition, peroxide based compounds being mostly alkaline in nature will also help facilitate the neutralization of oral acid. Over time, as these plaques and acidic byproducts are reduced the progression of carious lesions and that of calculus accumulation upon the teeth is also substantially curtailed.

When, therefore, one or more peroxide based compounds are used, their individual concentrations will vary to some extent upon the types of peroxide compounds employed and the final formulation used in the FED floss. As a result, substantial leeway in both use and concentration is allowed but both the quantity as well as the level of alkalinity must be of a safe level. Assimilation of these peroxide compounds into the flavor enhanced dental floss can be performed in a fashion similar to, but not limited to, that used by polishing or abrading agents.

Pigmenting Agents

Flavor enhanced dental flosses may also make use of one or more colouring or pigmenting agents. These pigmenting agents may be obtained from either natural or synthetic sources, or a combination thereof. Thus, by way of example and not limitation, some common available colouring agents may include FD and C-type dyes and lakes, fruit and vegetable extracts, titanium dioxide, silicon dioxide, and the like. Suitable pigmenting agents may also be used to colour the filaments or fibres comprising the floss as a means of producing a decorative effect or as a means of signifying or designating certain formulations.

The pigmenting agent titanium dioxide is, however, particularly useful because of its brilliant opaque white colour and its extremely small particle size. Though a larger size may be used, titanium dioxide and other such particles which have been found useful in the present invention have an approximate size of 1.5 microns or less, but preferably an approximate size of 0.1 microns or less, and most preferably an approximate size of 0.04 microns or less. A pigmenting agent having this approximate size allows it to be absorbed or retained by the enamel and dentinal layers of the teeth and so occupy the space between the hydroxyapatite crystals or prisms that make up these layers. In this way, these small titanium dioxide particles can compete with the substances that tend to attack, stain or discolour teeth by filling the space between the prisms with an inert white material instead of an undesirable substance or colouring. A further benefit of titanium dioxide as the pigmenting agent is its ability to also function as a mild polishing or abrading agent when it is being used. Moreover, titanium dioxide particles can be easily incorporated into the flavor enhanced dental floss in a fashion similar to, but not limited to, that utilized by polishing or abrading agents.

Miscellaneous Information Regarding FED Flosses

The following patents, the entire contents of which are hereby incorporated by reference into this specification, offers the reader a supplementary appendage of current flossing ingredients, compounds, and manufacturing methods. In addition, this information may also be use as required in the manufacture of the FED flosses herein disclosed.

| | | |
|---|---|---|
| (1) | U.S. Pat. No.: | 5,573,850 |
| | Invented by: | David V. Cunningham, Sheldon Kavesh, |
| | | and Christopher P. Griffin. |
| | Issued: | Nov. 12, 1996 |
| (2) | U.S. Pat. No.: | 5,560,377 |
| | Invented by: | Marion Donovan. |
| | Issued: | Oct. 1, 1996 |
| (3) | U.S. Pat. No.: | 5,526,831 |
| | Invented by: | Sean G. Gilligan, Dermot T. Freeman, |
| | | Larry J. Oliphant, Jeffrey S. Meessmann, |
| | | Patrick J. Hanley, and Gerald S. Szczech. |
| | Issued: | Jun. 18, 1996 |
| (4) | U.S. Pat. No.: | 5,423,337 |
| | Issued: | Jun. 13, 1995 |
| (5) | U.S. Pat. No.: | 5.357,990 |
| | Invented by: | Christopher H. Suhonen, |
| | | and John A. Kaminski. |
| | Issued: | Oct. 25, 1994 |
| (6) | U.S. Pat. No.: | 5,353,820 |
| | Invented by: | Christopher H. Suhonen, and Pedro L. Jusino. |
| | Issued: | Oct. 11, 1994 |
| (7) | U.S. Pat. No.: | 5,220,932 |
| | Invented by: | Jacob M. Blass. |
| | Issued: | Jun. 22, 1993 |
| (8) | U.S. Pat. No.: | 5,209,251 |
| | Invented by: | John P. Curtis, and James H. Kemp. |
| | Issued: | May 11, 1993 |
| (9) | U.S. Pat. No.: | 5,098,711 |
| | Invented by: | Ira Hill, and Robert D. White. |
| | Issued: | Mar. 24, 1992 |
| (10) | U.S. Pat. No.: | 4,548,219 |
| | Invented by: | Michael G. Newman. |
| | Issued: | Oct. 22, 1985 |

Formulations

The information so far presented has given the reader the ability to produce a large number of FED floss formulations. With this in mind, the disclosure will now detail, using a percent weight per weight (W/W) format, ten specific examples which can be used to produce the effects desired. Thus, by way of example and not limitation, the following formulations comprise:

Formulation Number One:

(a) a maximum of about 41.6 percent (W/W) binder with about 41.6 percent (W/W) being optimal;

(b) a maximum of about 71.4 percent (W/W) flavoring agent with about 41.6 percent (W/W) being optimal; and

(c) a maximum of about 16.8 percent (W/W) emulsifying agent with about 16.8 percent (W/W) being optimal.

Formulation Number Two:

(a) a maximum of about 41.6 percent (W/W) binder with about 35.8 percent (W/W) being optimal;

(b) a maximum of about 71.4 percent (W/W) flavoring agent with about 35.8 percent (W/W) being optimal;

(c) a maximum of about 16.8 percent (W/W) emulsifying agent with about 14.2 percent (W/W) being optimal; and

(d) a maximum of about 37.0 percent (W/W) water with about 14.2 percent (W/W) being optimal.

Formulation Number Three:

(a) a maximum of about 41.6 percent (W/W) binder with about 26.6 percent (W/W) being optimal;

(b) a maximum of about 71.4 percent (W/W) flavoring agent with about 71.4 percent (W/W) being optimal;

(c) a maximum of about 16.8 percent (W/W) emulsifying agent with about 10.5 percent (W/W) being optimal; and

(d) a maximum of about 37.0 percent (W/W) water with about 10.5 percent (W/W) being optimal.

Formulation Number Four:

(a) a maximum of about 41.6 percent (W/W) binder with about 22.8 percent (W/W) being optimal;

(b) a maximum of about 71.4 percent (W/W) flavoring agent with about 45.4 percent (W/W) being optimal;

(c) a maximum of about 16.8 percent (W/W) emulsifying agent with about 9.0 percent (W/W) being optimal; and

(d) a maximum of about 37.0 percent (W/W) water with about 22.8 percent (W/W) being optimal.

Formulation Number Five:

(a) a maximum of about 41.6 percent (W/W) binder with about 18.5 percent (W/W) being optimal;

(b) a maximum of about 71.4 percent (W/W) flavoring agent with about 37.0 percent (W/W) being optimal;

(c) a maximum of about 16.8 percent (W/W) emulsifying agent with about 7.5 percent (W/W) being optimal; and

(d) a maximum of about 37.0 percent (W/W) water with about 37.0 percent (W/W) being optimal.

Formulation Number Six:

(a) a maximum of about 41.6 percent (W/W) binder with about 15.0 percent (W/W) being optimal;

(b) a maximum of about 71.4 percent (W/W) flavoring agent with about 45.0 percent (W/W) being optimal;

(c) a maximum of about 16.8 percent (W/W) emulsifying agent with about 9.0 percent (W/W) being optimal; and

(d) a maximum of about 37.0 percent (W/W) water with about 31.0 percent (W/W) being optimal.

Formulation Number Seven:

(a) a maximum of about 22.8 percent (W/W) binder with about 22.8 percent (W/W) being optimal;

(b) a maximum of about 22.8 percent (W/W) flavoring agent with about 22.8 percent (W/W) being optimal;

(c) a maximum of about 8.8 percent (W/W) emulsifying agent with about 8.8 percent (W/W) being optimal; and

(d) a maximum of about 27.0 percent (W/W) water with about 22.8 percent (W/W) being optimal.

(e) a maximum of about 47.0 percent (W/W) Xylitol with about 22.8 percent (W/W) being optimal.

Formulation Number Eight:

(a) a maximum of about 22.8 percent (W/W) binder with about 18.5 percent (W/W) being optimal;

(b) a maximum of about 27.0 percent (W/W) flavoring agent with about 18.5 percent (W/W) being optimal;

(c) a maximum of about 8.8 percent (W/W) emulsifying agent with about 7.4 percent (W/W) being optimal; and

(d) a maximum of about 22.8 percent (W/W) water with about 18.5 percent (W/W) being optimal.

(e) a maximum of about 47.0 percent (W/W) Xylitol with about 37.1 percent (W/W) being optimal.

Formulation Number Nine:

(a) a maximum of about 22.8 percent (W/W) binder with about 15.6 percent (W/W) being optimal;

(b) a maximum of about 27.0 percent (W/W) flavoring agent with about 15.6 percent (W/W) being optimal;

(c) a maximum of about 8.8 percent (W/W) emulsifying agent with about 6.2 percent (W/W) being optimal; and

(d) a maximum of about 22.8 percent (W/W) water with about 15.6 percent (W/W) being optimal.

(e) a maximum of about 47.0 percent (W/W) Xylitol with about 47.0 percent (W/W) being optimal.

Formulation Number Ten:

(a) a maximum of about 22.8 percent (W/W) binder with about 13.5 percent (W/W) being optimal;

(b) a maximum of about 27.0 percent (W/W) flavoring agent with about 27.0 percent (W/W) being optimal;

(c) a maximum of about 8.8 percent (W/W) emulsifying agent with about 5.4 percent (W/W) being optimal; and

(d) a maximum of about 22.8 percent (W/W) water with about 13.5 percent (W/W) being optimal.

(e) a maximum of about 47.0 percent (W/W) Xylitol with about 40.6 percent (W/W) being optimal.

During the experimentation processes herein undertaken it has also been unexpectedly discovered that the most significant releases of flavor were not achieved by increasing the flavoring component of the formulations listed but by adding or incorporating Xylitol therein. This discovery is quite unique and produces a flavor release that is not only extremely intense but also long lasting.

In addition, the chemical and biological nature of Xylitol also provides the FED floss with antibacterial properties the operational theory of which is herein summarized below by Dr. Lawrence Wayne Nash.

Xylitol: Antibacterial Theory of Operation

Chemically speaking, Xylitol is a sugar alcohol or polyol and not a sugar but is referred to as birch sugar because it can be produced from birch trees. It is found in nature in many sources such as rowan berries, strawberries, plums, and other berries. Moreover, it has also been theorized by contemporary scientists that Xylitol's five carbon sugar alcohol structure is unsuitable as an energy source for most oral microorganisms such as Streptococcus mutans. That is because microorganisms like these, having once transported Xylitol into the their cell, must then phosphorylate it into Xylitol-5-phosphate . . . a compound which must be expelled later. As a result, this becomes a metabolically futile cycle which consumes enough of the cell's energy stores to hinder or disable microorganisms like Streptococcus mutans from reproducing.

This applicant, however, theorizes that the mechanism of bacterial inhibition of Streptococcus mutans is related more to the inherent capacity of Xylitol's alcohol structure to induce both protein denaturing and coagulation as well as lipid disruption. Consequently, this will help to reduce or prohibit bacterial reproduction and so thereby reduce or eliminate the effects of Streptococcus mutans in the oral environment. This is significant in that Streptococcus mutans is generally considered to be the most influential bacterium in the large group of organisms associated with dental caries.

In conclusion, the use of Xylitol in a Flavor Enhanced Dental floss should therefore provide a marked improvement in the ability of this floss to combat many undesirable microbial organisms and their ill effects.

Formulations: Other Considerations

The reader should also understand that while many different ingredients, compounds, and substances may be used in the above formulations the following substances have been found to be preferable. They are listed as follows: microcrystalline wax to be used as the binder, sorbitan monostearate to be used as the emulsifying agent, deionized water whenever water is used, Xylitol to be used as the sweetener, and sodium fluoride to be used as the fluoride compound.

Flavorings, on the other hand, are basically unrestricted as both selection and concentration are generally governed by consumer preferences, logistical availability, or cost considerations. That is, they have no real or actual bearing upon the safety or efficacy of the final product itself. However, four flavorings have been found to be distinctive, aromatic, long lasting, and desirable. They are Hagelin flavoring #640047, Hagelin flavoring #640057, Hagelin flavoring #671009, Hagelin flavoring #671010, used alone or in combination. As such, these four flavorings shall be given preferential status within this invention so as to set apart or distinguish it from competitors. Note also, that Hagelin flavorings may be procured from Hagelin & Company, Inc., 200 Meister Avenue, Branchburg, N.J., U.S.A., 08876-6033.

However, it must also be understood that any variances or deviations from a formulation's stated optimal figures must still be accounted for, on a similar percentage weight per weight basis, in one or more of the other components. What this means, in other words, is that a quantitative reduction or increase in the amount of flavoring used, or for that matter any other ingredient, must be accounted for by similarly or respectively increasing or decrease the quantity of one or more of the other components listed. The allows the sum of a formulation's component (W/W)s to still total 100 percent.

For example, if the flavoring used within Formulation Number One is reduced from 41.6 percent (W/W) to 40.0 percent (W/W) it will require a correspondingly similar increase in the amount of microcrystalline wax used. As such, the original optimal tally of microcrystalline wax must be increased from 41.6 percent (W/W) to 43.2 percent (W/W) of the formulation. This type of procedure shall, for the purpose of this disclosure, be herein referred to as Quantitative Formulation Balancing or QFB.

If a fluoride compound is also to be used within any of the above formulations it should preferably be sodium fluoride and it should amount to no more than 0.30 percent (W/W) of the formulations listed above. However, it has been found that setting the maximum fluoride range at 0.24 percent (W/W) is preferable with 0.22 to 0.24 percent (W/W) being the best overall zone to use. Moreover, whenever a fluoride compound is employed the amount of microcrystalline wax used should also be quantitatively diminished by that same amount. Thus, for example, if 0.22 percent (W/W) sodium fluoride is to be utilized within Formulation Number One then the quantity of microcrystalline wax must be similarly or respectively reduced by that same amount and so total 41.6 minus 0.22 or 41.38 percent (W/W) of the formulation.

In most cases herein disclosed, Quantitative Formulation Balancing may be respectively achieved, on a (W/W) basis, by a similar inverse decrease or increase in the amount of microcrystalline wax employed. As such, it becomes self-evident that the purpose of microcrystalline wax is not just to provide lubrication, thread binding, and component scaffolding but formulation balancing as well.

Although microcrystalline wax may offer or yield a number of formulation balancing opportunities other ingredients may also be used. As such, two charts are conveniently provided below so that the reader may more fully understand various Quantitative Formulation Balancing techniques and the opportunities that they offer to individually tailor certain formulations to specific needs.

Quantitative Formulation Balancing Techniques for all Formulations

First and foremost, the reader should clearly understand that a formulation's optimal (W/W) figures are used as the base or reference line during any Quantitative Formulation Balancing operations. Consequently, any ingredients added or subtracted are referenced back to these starting points. Note also, that the term “original ratio” shall always refer herein, to that ratio between microcrystalline wax and sorbitan monostearate that existed prior to any QFB.

Formulations without Xylitol—Decreasing from Optimal:

(a) Microcrystalline wax:

Balance by decreasing sorbitan monostearate so as to maintain the same original ratio between the two as before the reduction of microcrystalline wax. Then increase the amount of flavoring to balance. Water and fluoride remain the same.

(b) Flavoring:

Balance by decreasing water first and then increasing the amount of microcrystalline wax to balance. Sorbitan monostearate is also modified so as to maintain the same original ratio between it and the microcrystalline wax. Flavoring, on the other hand, remains the same.

(c) Sorbitan monostearate:

Balance by similarly decreasing the amount of microcrystalline wax so as to maintain the same original ratio. Finally, increase flavoring in order to complete QFB. Water and fluoride are to remain the same.

(d) Water:

Decrease flavoring first. Next increase microcrystalline wax and sorbitan monostearate keep the original ratio intact. Flavoring and fluoride, however, remain the same.

(e) Sodium Fluoride:

Balance by equally increasing the amount of water. All other components remain the same.

Formulations without Xylitol—Increasing from Optimal:

(a) Microcrystalline wax:

Balancing by lowering the amount of flavoring while increasing sorbitan monostearate in order to maintain the same original ratio. Fluoride remains the same.

(b) Flavoring:

Balance by reducing microcrystalline wax and sorbitan monostearate so as to maintain the original ratio. Water remains the same.

(c) Sorbitan monostearate:

Balance by increasing microcrystalline wax to maintain the same original ratio while decreasing flavoring to complete QFB. Water and fluoride remain the same.

(d) Water:

Decrease the amount of flavoring. Microcrystalline wax and sorbitan monostearate remain the same.

(e) Sodium Fluoride:

Balance by similarly decreasing the amount of water. All other components remain the same.

Formulations with Xylitol—Decreasing from Optimal:

(a) Microcrystalline wax:

Balance by decreasing sorbitan monostearate so as to maintain same original ratio. Next, increase the amount of flavoring while decreasing both the quantity of Xylitol and water.

(b) Flavoring:

Balance by decreasing Xylitol while increasing both microcrystalline wax and sorbitan monostearate in order to maintain the same original ratio. Water and fluoride, however, remain the same.

(c) Sorbitan monostearate:

Balance by similarly decreasing the amount of microcrystalline wax so as to maintain the same original ratio. Flavoring is then increased while Xylitol is reduced. Water and fluoride, however, remain the same.

(d) Water:

Balance by reducing Xylitol while increasing flavoring. The quantities of microcrystalline wax and sorbitan monostearate remain the same as does the amount of fluoride.

(e) Xylitol:

Decrease the quantity of water and flavoring. The amount of microcrystalline wax and sorbitan monostearate remain the same as does the amount of fluoride.

(f) Sodium Fluoride:

Balance by similarly increasing the amount of water. All other components remain the same.

Formulations with Xylitol—Increasing from Optimal:

(a) Microcrystalline wax:

Balancing by increasing sorbitan monostearate in order to maintain the same original ratio while decreasing both the amount of flavoring and the amount of Xylitol. Water and fluoride, however, remain the same.

(b) Flavoring:

Balance by simultaneously reducing both microcrystalline wax and sorbitan monostearate in order to maintain the same original ratio. Water, Xylitol, and fluoride, however, remain the same.

(c) Sorbitan monostearate:

Balance by increasing microcrystalline wax so as to maintain the same original ratio. Next, reduce water and then Xylitol while increasing flavoring. Fluoride remains the same.

(d) Water:

Balance by increasing Xylitol and decreasing flavoring. Microcrystalline wax, sorbitan monostearate, and fluoride remain the same.

(e) Xylitol:

Decrease the amount of flavoring. The amount of microcrystalline wax, sorbitan monostearate, water, and fluoride remain the same.

(f) Sodium Fluoride:

Balance by similarly decreasing the amount of water. All other components remain the same.

Note also, that in order to help preserve chemical efficacy over extended periods and prevent chemical interactions during storage some or all of the substances detailed herein may be encapsulated or microcoated. However, all such encapsulating or microcoating materials utilized within a given formulation should be the same, so that a simultaneous release and thus interaction of all chemical compounds may be realized when the floss is used.

Moreover, within a given formulation, each ingredient is permitted a range or a tolerance of about plus or minus five percent of the amount specified in order to allow for manufacturing variances. Thus, for example, microcrystalline wax being set herein at 41.6 percent (W/W) in Formulations Number One may actually range from 39.52 to 43.68 percent (W/W).

Finally, the formulations detailed above may be prepared, prior to their deposition upon a dental floss, by using the following methods. For the purpose of this disclosure these two methods shall both be classified as Staged Preparation Techniques. Using these methods will assure the production of a high quality FED floss time and time again. It must also be understood, that although these methods are highly preferred other techniques are possible. As a result, the methods provided herein should be considered illustrative and not limiting in nature.

Staged Preparation Technique—without Xylitol

(a) This method begins by first melting microcrystalline wax within a suitable container until it is liquified.

(b) Once the microcrystalline wax has been liquified sorbitan monostearate is then added to the liquified microcrystalline wax in a conventional manner. The resulting composition is then mixed until visually homogenous.

(c) Next, add the flavoring component and mix until visually homogenous.

(d) Now add any water and or fluoride called for by the formulation chosen and mix until visually homogenous.

(e) Apply the resultant mixture to floss in a conventional manner.

Staged Preparation Technique—with Xylitol

(a) This method begins by first melting microcrystalline wax within a suitable container until it is liquified.

(b) Once the microcrystalline wax has been liquified sorbitan monostearate is then added to the liquified microcrystalline wax in a conventional manner. The resulting composition is then mixed until visually homogenous.

(c) Next, add the flavoring component and mix until visually homogenous.

(d) A second container is now procured and in it is thoroughly mixed, using conventional methods, any water and Xylitol that are to be utilized herein. If sodium fluoride or other fluoride based compound is also to be used within the formulation it is added, along with any other ingredients, at this time.

(e) Once the composition of step (d) is completed it is then added to the mixture produced by step (c) and thoroughly mixed, using conventional means, until visually homogenous.

(f) The resulting composition produced by step (e) is then uniformly applied to dental floss using conventional techniques.

Closing Thoughts

The many benefits offered by this new flavor enhanced dental floss are both innovative as well as highly desirable. Moreover, these advantages, some of which are recorded below, also help the reader to better understand this product's true worth.

(1) By creating a floss with exceptionally good flavor characteristics consumers will be much more likely to use it, thereby substantially increasing the overall level of flossing within the general population.

(2) The superior flavor release demonstrated by this new floss is not only immediately evident but long lasting as well.

(3) By adding one or more fluoride based compounds to this new floss, oral dental health is improved further still.

(4) Various abrading or pigmenting agents may also be used by this new floss in order to respectively provide cleaner dental surfaces or whiter teeth. In turn, this will not only help reduce dental decay but also increase the therapeutic effectiveness of other medicaments.

(5) This new floss, though revolutionary in its manufacture, is not expensive to make, but is rather well within traditional expectations.

(6) The manufacture of this new dental floss requires no major alterations to existing equipment or facilities but is instead readily compatible with conventional machines and processes. As such, costs are kept low and market penetration expedited.

(7) The chemical stability of this new floss is remarkable. This, therefore, provides not only a long shelf life but lower shipping, storage, and spoilage costs as well.

Addendum

The following references, the entire contents of which are hereby incorporated by reference into this specification, further elaborate and detail other ingredients, procedures, and information which may be of use in the disclosure herein.

(1) Accepted Dental Therapeutics, 39th Edition, Copyright 1982, by the American Dental Association, 211 E. Chicago Ave., Chicago, Ill., U.S.A., 60611. Library of Congress Number: 74[2]-MCAT

(2) Comprehensive Dental Hygiene Care, 4th Edition, Written by: Irene R. Woodall, Copyright 1993, by Mosby—Year Book, Inc., 11830 Westline Industrial Drive, St. Louis, Mo., U.S.A., 63146. ISBN: 0-8016-7019-5

(3) The Merck Manual, Executive Editor: Keryn A. G. Lane, Copyright 1999, by Merck and Co., Inc., Whitehouse Station, N.J., U.S.A., Publisher: Gary Zelko. ISBN: 0911910-10-7

(4) Fenaroli's Handbook of Flavor Ingredients, Written by: Prof. Dr. Giovanni Fenaroli, Copyright 1971, by the Chemical Rubber Company, 18901 Cranwood Pkwy., Cleveland, Ohio, U.S.A., 44128. Library of Congress Number: 72-152143

(5) Flavor Technology, Profiles, Products, Applications, Written by: Henry B. Heath, M. B. E., B.Pharm.(London), Copyright 1978, Avi Publishing Company Incorporated, Westport, Conn., U.S.A. ISBN: 0-87005-258-9

Additional information regarding the subject of this invention can be found in the many books available to the public at libraries and technical centres or in the many patents and government publications currently available today.

Finally, the reader must also understand that the preceding description contains many specificities that should not be construed as limiting the scope of the invention but as merely providing illustrations of some of the presently preferred embodiments thereof. As a result, the scope of the invention should thus be determined by the appended claims and their legal equivalents rather than by the examples given.

The embodiments of the invention in which an exclusive property or privilege is claimed are defined as follows:

1. An flavor enhanced dental floss comprising a dental floss and a formulation, and wherein said formulation is selected from the group consisting of:
Formulation number one:
(a) a maximum of about 41.6 percent (W/W) binder with about 41.6 percent (W/W) being optimal;
(b) a maximum of about 71.4 percent (W/W) flavoring agent with about 41.6 percent (W/W) being optimal; and
(c) a maximum of about 16.8 percent (W/W) emulsifying agent with about 16.8 percent (W/W) being optimal.
Formulation Number Two:
(a) a maximum of about 41.6 percent (W/W) binder with about 35.8 percent (W/W) being optimal;
(b) a maximum of about 71.4 percent (W/W) flavoring agent with about 35.8 percent (W/W) being optimal;
(c) a maximum of about 16.8 percent (W/W) emulsifying agent with about 14.2 percent (W/W) being optimal; and
(d) a maximum of about 37.0 percent (W/W) water with about 14.2 percent (W/W) being optimal.
Formulation Number Three:
(a) a maximum of about 41.6 percent (W/W) binder with about 26.6 percent (W/W) being optimal;
(b) a maximum of about 71.4 percent (W/W) flavoring agent with about 71.4 percent (W/W) being optimal;
(c) a maximum of about 16.8 percent (W/W) emulsifying agent with about 10.5 percent (W/W) being optimal; and
(d) a maximum of about 37.0 percent (W/W) water with about 10.5 percent (W/W) being optimal.
Formulation Number Four:
(a) a maximum of about 41.6 percent (W/W) binder with about 22.8 percent (W/W) being optimal;
(b) a maximum of about 71.4 percent (W/W) flavoring agent with about 45.4 percent (W/W) being optimal;
(c) a maximum of about 16.8 percent (W/W) emulsifying agent with about 9.0 percent (W/W) being optimal; and
(d) a maximum of about 37.0 percent (W/W) water with about 22.8 percent (W/W) being optimal.
Formulation Number Five:
(a) a maximum of about 41.6 percent (W/W) binder with about 18.5 percent (W/W) being optimal;
(b) a maximum of about 71.4 percent (W/W) flavoring agent with about 37.0 percent (W/W) being optimal;
(c) a maximum of about 1 6.8 percent (W/W) emulsifying agent with about 7.5 percent (W/W) being optimal; and
(d) a maximum of about 37.0 percent (W/W) water with about 37.0 percent (W/W) being optimal.
Formulation Number Six:
(a) a maximum of about 41.6 percent (W/W) binder with about 15.0 percent (W/W) being optimal;
(b) a maximum of about 71.4 percent (W/W) flavoring agent with about 45.0 percent (W/W) being optimal;
(c) a maximum of about 16.8 percent (W/W) emulsifying agent with about 9.0 percent (W/W) being optimal; and
(d) a maximum of about 37.0 percent (W/W) water with about 31.0 percent (W/W) being optimal.
Formulation Number Seven:
(a) a maximum of about 22.8 percent (W/W) binder with about 22.8 percent (W/W) being optimal;
(b) a maximum of about 22.8 percent (W/W) flavoring agent with about 22.8 percent (W/W) being optimal;
(c) a maximum of about 8.8 percent (W/W) emulsifying agent with about 8.8 percent (W/W) being optimal; and
(d) a maximum of about 27.0 percent (W/W) water with about 22.8 percent (W/W) being optimal.
(e) a maximum of about 47.0 percent (W/W) Xylitol with about 22.8 percent (W/W) being optimal.
Formulation Number Eight:
(a) a maximum of about 22.8 percent (W/W) binder with about 18.5 percent (W/W) being optimal;
(b) a maximum of about 27.0 percent (W/W) flavoring agent with about 18.5 percent (W/W) being optimal;
(c) a maximum of about 8.8 percent (W/W) emulsifying agent with about 7.4 percent (W/W) being optimal; and
(d) a maximum of about 22.8 percent (W/W) water with about 18.5 percent (W/W) being optimal.
(e) a maximum of about 47.0 percent (W/W) Xylitol with about 37.1 percent (W/W) being optimal.
Formulation Number Nine:
(a) a maximum of about 22.8 percent (W/W) binder with about 15.6 percent (W/W) being optimal;
(b) a maximum of about 27.0 percent (W/W) flavoring agent with about 15.6 percent (W/W) being optimal;
(c) a maximum of about 8.8 percent (W/W) emulsifying agent with about 6.2 percent (W/W) being optimal; and
(d) a maximum of about 22.8 percent (W/W) water with about 15.6 percent (W/W) being optimal.
(e) a maximum of about 47.0 percent (W/W) Xylitol with about 47.0 percent (W/W) being optimal.
Formulation Number Ten:
(a) a maximum of about 22.8 percent (W/W) binder with about 13.5 percent (W/W) being optimal;
(b) a maximum of about 27.0 percent (W/W) flavoring agent with about 27.0 percent (W/W) being optimal;
(c) a maximum of about 8.8 percent (W/W) emulsifying agent with about 5.4 percent (W/W) being optimal; and
(d) a maximum of about 22.8 percent (W/W) water with about 13.5 percent (W/W) being optimal.
(e) a maximum of about 47.0 percent (W/W) Xylitol with about 40.6 percent (W/W) being optimal.

2. The claim as recited in claim 1 wherein said flavor enhanced dental floss is made by using a Staged Preparation Technique.

3. The claim as recited in claim 2 wherein a Quantitative Formulation Balancing technique is used to adjust the formulations of the flavor enhanced dental floss.

4. The claim as recited in claim 3 wherein said binder is microcrystalline wax, said emulsifying agent is sorbitan monostearate, and said water is deionized water.

5. The claim as recited in claim 4 wherein said formulations further include at least one compound selected from the group consisting of fluoride based compounds, peroxide based compounds, abrading agents, pigmenting agents, encapsulating compounds, and microcoating compounds, alone or in combination.

6. The claim as recited in claim 3 wherein said formulations further include at least one compound selected from the group consisting of fluoride based compounds, peroxide based compounds, abrading agents, pigmenting agents, encapsulating compounds, and microcoating compounds, alone or in combination.

7. The claim as recited in claim 2 wherein said binder is microcrystalline wax, said emulsifying agent is sorbitan monostearate, and said water is deionized water.

8. The claim as recited in claim 2 wherein said formulations further include at least one compound selected from the group consisting of fluoride based compounds, peroxide based compounds, abrading agents, pigmenting agents, encapsulating compounds, and microcoating compounds, alone or in combination.

9. The claim as recited in claim 1 wherein a Quantitative Formulation Balancing technique is used to adjust the formulations of the flavor enhanced dental floss.

10. The claim as recited in claim 9 wherein said binder is microcrystalline wax, said emulsifying agent is sorbitan monostearate, and said water is deionized water.

11. The claim as recited in claim 10 wherein said formulations further include at least one compound selected from the group consisting of fluoride based compounds, peroxide based compounds, abrading agents, pigmenting agents, encapsulating compounds, and microcoating compounds, alone or in combination.

12. The claim as recited in claim 9 wherein said formulations further include at least one compound selected from the group consisting of fluoride based compounds, peroxide based compounds, abrading agents, pigmenting agents, encapsulating compounds, and microcoating compounds, alone or in combination.

13. The claim as recited in claim 1 wherein said binder is microcrystalline wax, said emulsifying agent is sorbitan monostearate, and said water is deionized water.

14. The claim as recited in claim 13 wherein said formulations further include at least one compound selected from the group consisting of fluoride based compounds, peroxide based compounds, abrading agents, pigmenting agents, encapsulating compounds, and microcoating compounds, alone or in combination.

15. The claim as recited in claim 1 wherein said formulations further include at least one compound selected from the group consisting of fluoride based compounds, peroxide based compounds, abrading agents, pigmenting agents, encapsulating compounds, and microcoating compounds, alone or in combination.

16. A method for reducing dental plaques and caries in the interproximal and subgingival areas of the teeth comprising the steps of:
(I) providing a dental floss;
(II) providing a formulation selected from the group consisting of:
Formulation Number One:
(a) a maximum of about 41.6 percent (W/W) binder with about 41.6 percent (W/W) being optimal;
(b) a maximum of about 71.4 percent (W/W) flavoring agent with about 41.6 percent (W/W) being optimal; and
(c) a maximum of about 16.8 percent (W/W) emulsifying agent with about 16.8 percent (W/W) being optimal.
Formulation Number Two:
(a) a maximum of about 41.6 percent (W/W) binder with about 35.8 percent (W/W) being optimal;
(b) a maximum of about 71.4 percent (W/W) flavoring agent with about 35.8 percent (W/W) being optimal;
(c) a maximum of about 16.8 percent (W/W) emulsifying agent with about 14.2 percent (W/W) being optimal; and
(d) a maximum of about 37.0 percent (W/W) water with about 14.2 percent (W/W) being optimal.
Formulation Number Three:
(a) a maximum of about 41.6 percent (W/W) binder with about 26.6 percent (W/W) being optimal;
(b) a maximum of about 71.4 percent (W/W) flavoring agent with about 71.4 percent (W/W) being optimal;
(c) a maximum of about 16.8 percent (W/W) emulsifying agent with about 10.5 percent (W/W) being optimal; and
(d) a maximum of about 37.0 percent (W/W) water with about 10.5 percent (W/W) being optimal.
Formulation Number Four:
(a) a maximum of about 41.6 percent (W/W) binder with about 22.8 percent (W/W) being optimal;
(b) a maximum of about 71.4 percent (W/W) flavoring agent with about 45.4 percent (W/W) being optimal;
(c) a maximum of about 16.8 percent (W/W) emulsifying agent with about 9.0 percent (W/W) being optimal; and
(d) a maximum of about 37.0 percent (W/W) water with about 22.8 percent (W/W) being optimal.
Formulation Number Five:
(a) a maximum of about 41.6 percent (W/W) binder with about 18.5 percent (W/W) being optimal;
(b) a maximum of about 71.4 percent (W/W) flavoring agent with about 37.0 percent (W/W) being optimal;
(c) a maximum of about 16.8 percent (W/W) emulsifying agent with about 7.5 percent (W/W) being optimal; and
(d) a maximum of about 37.0 percent (W/W) water with about 37.0 percent (W/W) being optimal.
Formulation Number Six:
(a) a maximum of about 41.6 percent (W/W) binder with about 15.0 percent (W/W) being optimal;
(b) a maximum of about 71.4 percent (W/W) flavoring agent with about 45.0 percent (W/W) being optimal;
(c) a maximum of about 16.8 percent (W/W) emulsifying agent with about 9.0 percent (W/W) being optimal; and
(d) a maximum of about 37.0 percent (W/W) water with about 31.0 percent (W/W) being optimal.
Formulation Number Seven:
(a) a maximum of about 22.8 percent (W/W) binder with about 22.8 percent (W/W) being optimal;
(b) a maximum of about 22.8 percent (W/W) flavoring agent with about 22.8 percent (W/W) being optimal;
(c) a maximum of about 8.8 percent (W/W) emulsifying agent with about 8.8 percent (W/W) being optimal; and
(d) a maximum of about 27.0 percent (W/W) water with about 22.8 percent (W/W) being optimal.
(e) a maximum of about 47.0 percent (W/W) Xylitol with about 22.8 percent (W/W) being optimal.
Formulation Number Eight:
(a) a maximum of about 22.8 percent (W/W) binder with about 18.5 percent (W/W) being optimal;
(b) a maximum of about 27.0 percent (W/W) flavoring agent with about 18.5 percent (W/W) being optimal;
(c) a maximum of about 8.8 percent (W/W) emulsifying agent with about 7.4 percent (W/W) being optimal; and
(d) a maximum of about 22.8 percent (W/W) water with about 18.5 percent (W/W) being optimal.
(e) a maximum of about 47.0 percent (W/W) Xylitol with about 37.1 percent (W/W) being optimal.
Formulation Number Nine:
(a) a maximum of about 22.8 percent (W/W) binder with about 15.6 percent (W/W) being optimal;
(b) a maximum of about 27.0 percent (W/W) flavoring agent with about 15.6 percent (W/W) being optimal;
(c) a maximum of about 8.8 percent (W/W) emulsifying agent with about 6.2 percent (W/W) being optimal; and
(d) a maximum of about 22.8 percent (W/W) water with about 15.6 percent (W/W) being optimal.
(e) a maximum of about 47.0 percent (W/W) Xylitol with about 47.0 percent (W/W) being optimal.
Formulation Number Ten:
(a) a maximum of about 22.8 percent (W/W) binder with about 13.5 percent (W/W) being optimal;
(b) a maximum of about 27.0 percent (W/W) flavoring agent with about 27.0 percent (W/W) being optimal;
(c) a maximum of about 8.8 percent (W/W) emulsifying agent with about 5.4 percent (W/W) being optimal; and
(d) a maximum of about 22.8 percent (W/W) water with about 13.5 percent (W/W) being optimal.
(e) a maximum of about 47.0 percent (W/W) Xylitol with about 40.6 percent (W/W) being optimal.
(III) contacting said formulation with said dental floss by incorporating said formulation therein or as a topical applicant in order to thereby produce a flavor enhanced dental floss; and
(IV) flossing with said flavor enhanced dental floss to thereby reduce plaques and caries.

17. The claim as recited in claim 16 wherein said flavor enhanced dental floss is made by using a Staged Preparation Technique.

18. The claim as recited in claim 17 wherein a Quantitative Formulation Balancing technique is used to adjust the formulations of the flavor enhanced dental floss.

19. The claim as recited in claim 16 wherein a Quantitative Formulation Balancing technique is used to adjust the formulations of the flavor enhanced dental floss.

20. A method for the production of dental floss formulations using a Staged Preparation Technique wherein said Staged Preparation Technique comprises the following steps:
Staged Preparation Technique—Without Xylitol
(a) This method begins by first melting microcrystalline wax within a suitable container until it is liquified.
(b) Once the microcrystalline wax has been liquified sorbitan monostearate is then added to the liquified microcrystalline wax in a conventional manner. The resulting composition is then mixed until visually homogenous.
(c) Next, add the flavoring component and mix until visually homogenous.
(d) Now add any water and or fluoride called for by the formulation chosen and mix until visually homogenous.
(e) Apply the resultant mixture to floss in a conventional manner.
Staged Preparation Technique—With Xylitol
(a) This method begins by first melting microcrystalline wax within a suitable container until it is liquified.
(b) Once the microcrystalline wax has been liquified sorbitan monostearate is then added to the liquified microcrystalline wax in a conventional manner. The resulting composition is then mixed until visually homogenous.
(c) Next, add the flavoring component and mix until visually homogenous.
(d) A second container is now procured and in it is thoroughly mixed, using conventional methods, any water and Xylitol that are to be utilized herein. If sodium fluoride or other fluoride based compound is also to be used within the formulation it is added, along with any other ingredients, at this time.
(e) Once the composition of step (d) is completed it is then added to the mixture produced by step (c) and thoroughly mixed, using conventional means, until visually homogenous.
(f) The resulting composition produced by step (e) is then uniformly applied to dental floss using conventional techniques.
